(19) United States
(12) Patent Application Publication
(10) Pub. No.: US 2008/0257905 A1
(43) Pub. Date: Oct. 23, 2008

(54) Dispensing Apparatus for Diagnostic Test Strip and/or Medicine

(76) Inventors: Jean-Pierre Giraud, Paris (FR); Michel Zbirka, Jouy-Sur-Morin (FR)

Correspondence Address: GREENBERG TRAURIG, LLP, MET LIFE BUILDING, 200 PARK AVENUE, NEW YORK, NY, 10166, US

(21) Appl. No.: 11/910,818

(22) PCT Filed: Apr. 6, 2006
(86) PCT No.: PCT/US2006/013165

§ 371 Date: May 7, 2008

Related U.S. Application Data
(60) Provisional application No. 60/668,692, filed on Apr. 6, 2005.

(51) Int. Cl. G07F 11/60

(52) U.S. Cl. 221/296; 221/244

(57) ABSTRACT

In one embodiment of the present invention a dispensing apparatus for a diagnostic test strip is provided. In another embodiment of the present invention a dispensing apparatus for medicine is provided.

### FIELD OF THE INVENTION

In one embodiment of the present invention a dispensing apparatus for a diagnostic test strip is provided.

In another embodiment of the present invention a dispensing apparatus for medicine is provided.

### BACKGROUND OF THE INVENTION

Diagnostics test strips often are moisture sensitive and need to be stored in containers that protect them from ambient moisture that they may be exposed to during both storage and use. It is advantageous to minimize the size of the containers for cost, space, and package size reasons. Reducing the physical size of the container, however can lead to increased difficulty in handling the strip, especially in certain patient populations such as the elderly. It is more difficult to remove the strips from the container.

Accordingly, one embodiment of the present invention relates to an improved dispensing apparatus for diagnostic test strips.

In another area, many postoperative patients report inadequate pain relief. In particular, cancer patients are typically unable to receive pain medication on an as needed basis unless hospitalized.

Adequate pain control requires the appropriate medication for the reported pain level. In a hospital setting, pain medication can be obtained by a physician's order and administered by hospital staff. A significant amount of time can elapse between the physician's order and the nurse administering the medication.

In this regard, the medication on demand apparatus of the present invention offers self-medication by the patient on an as-needed basis. Moreover, a second dose can be delivered essentially immediately after the first dose, if needed, without any significant time delay. This may promote patient autonomy and a more efficient drug delivery system, especially in a hospice type setting.

### BRIEF DESCRIPTION OF THE DRAWINGS

FIG. 1 shows two cross-sectional views (one with a cap open and one with a cap closed) of a test strip dispensing apparatus according to an embodiment of the present invention;

FIG. 2 shows a perspective view of a test strip dispensing apparatus according to an embodiment of the present invention (with a cap open);

FIG. 3 shows perspective views of certain components of the apparatus of FIG. 2;

FIGS. 4 and 5 show perspective views of certain components of a medicine dispensing apparatus according to an embodiment of the present invention (wherein a spring and other components are shown removed from a container)

FIGS. 6 and 7 show perspective views of certain components of a medicine dispensing apparatus according to an embodiment of the present invention (wherein a spring and other components partially extend from a container);

FIG. 8 shows a perspective view of a medicine dispensing apparatus according to an embodiment of the present invention (wherein a spring is within a container and other components extend from the container); and

FIG. 9 shows perspective views of embodiments of a medicine dispensing apparatus (the left view showing a spring and other components partially extending from a container and the right view showing a spring within a container and other components extending from the container).

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

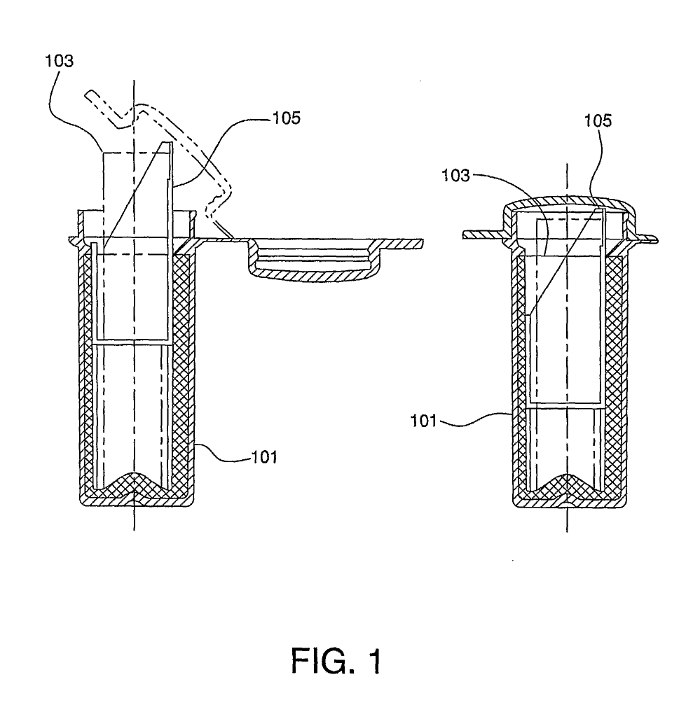

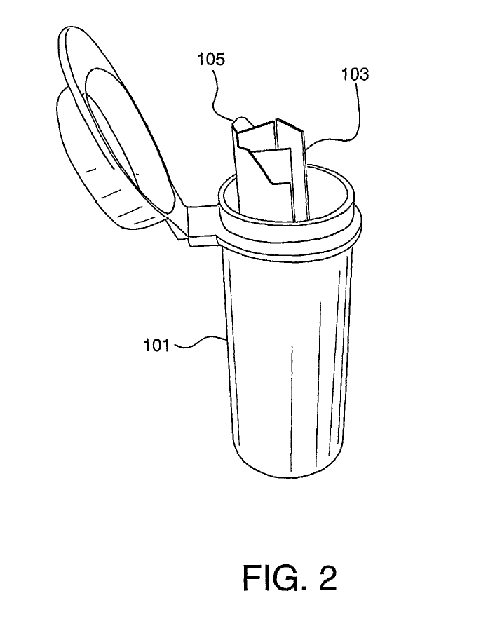

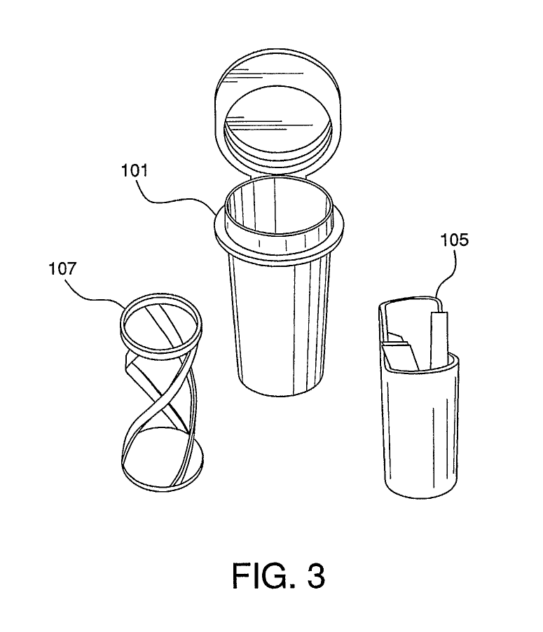

Referring now to FIG. 1, this Fig. illustrates one embodiment of the present invention and shows cross-sectional views of Container 101 with Elevating Cup 103 (for holding test strips) in the open and closed positions. FIG. 2 further illustrates Elevating Cup 103 and shows Elevating Cup 103 with Elevating Platform 105 (Elevating Cup 103 and Elevating Platform 105 may be separate components or a single integrated component). FIG. 3 further illustrates components of the present invention (including Spring 107—which may be used to upward bias Elevating Cup 103/Elevating Platform 105).

Of note, in one embodiment the present invention may comprise an integral cup (or sleeve) within the primary packaging container that elevates when the primary container is opened to allow access to the test strips, but then collapses back into the primary container when it is closed. The lid of the container may contact the cup or sleeve (pushing it down as the lid is closed). In one embodiment, when the lid contacts the sleeve, this lid/sleeve contact prevents damage to the strips from the closing of the container. In another embodiment, the sleeve may be keyed to prevent it from rotating (e.g., relative to the container). The diagnostic test strips may be housed in the sleeve, such that the primary packaging provides the protection from the ambient environment.

In yet another embodiment, the cup is an additional part that can be assembled to the primary container when it is manufactured, or the test strips can be loaded into the cup and then the cup assembled to the container.

The elevation may be accomplished by a spring element that can be integral to the cup, integral to the container, or a separate component.

In another embodiment, the present invention comprises an integral sleeve inside a primary packaging container that holds the product.

In another embodiment, the container, the integral sleeve (strip holder) and/or molding spring can be made of thermoplastic (e.g., polystyrene, polypropylene, polyethylene).

In one example, the use of a mold spring with the integral sleeve (strip holder) of the present invention may reduce cost by not requiring the need for precision with the spring component and/or by reducing the need for the spring being under compression during product shelf life.

In yet another embodiment, the primary container may contain a material that adsorbs or releases an active ingredient to protect or condition the product. The active ingredient may be composed of one or more of the following “active agents”: an absorbing material, a releasing material, and/or an activation material. A list of active agents includes, but is not limited to: desiccants, oxygen absorbers, odor absorbers, ethylene absorbers, CO₂ absorbers, fragrance/aroma release, and/or nutrient release. In a further embodiment, the container may be produced as two components—the polymer and the active agent. In another embodiment, the container may be produced as at least three components. One example of the three component composition is the compositions and methods disclosed in one or more of the following U.S. Pat. Nos.: 5,911,937, 6,214,255, 6,130,263, 6,080,350 and 6,174,952, 6,124,006, and 6,221,446. In another embodiment the container may be composed of a thermoplastic (e.g. polypropylene, polyethylene and mixtures thereof).

In a further embodiment, the present invention may comprise a sleeve that elevates the product so it can be removed or handled from a container that is minimized in size. In another embodiment, the present invention may comprise a sleeve that automatically elevates when the primary container is opened. In a further embodiment, the sleeve may be automatically pushed back into the primary container when it is closed. In another example, the sleeve may be “keyed” to prevent it from rotating.

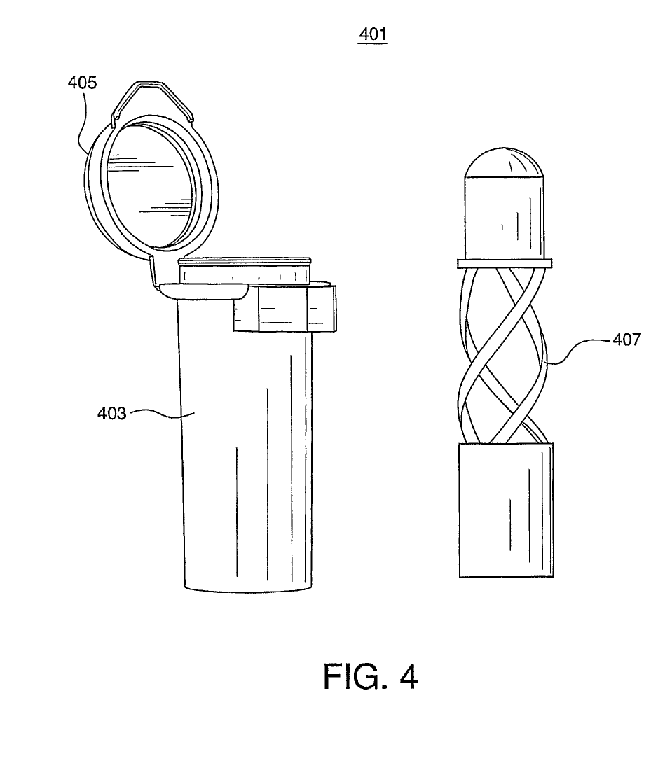

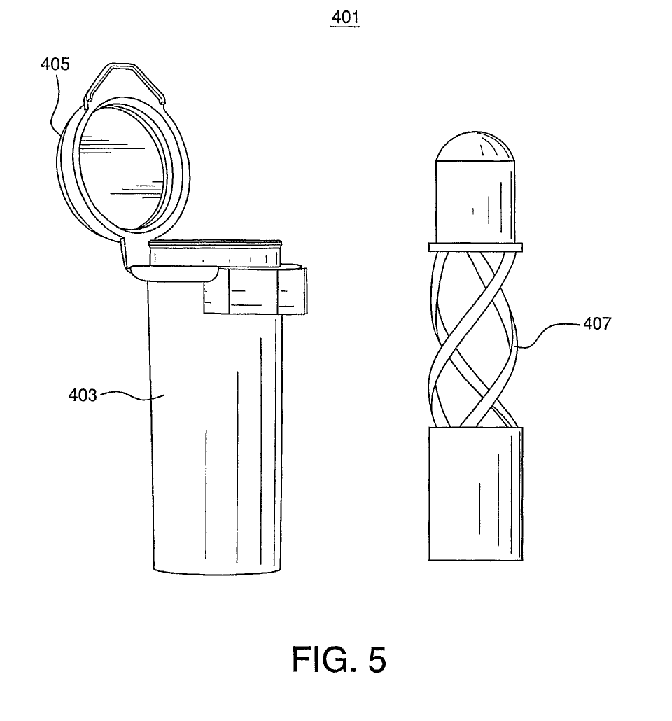

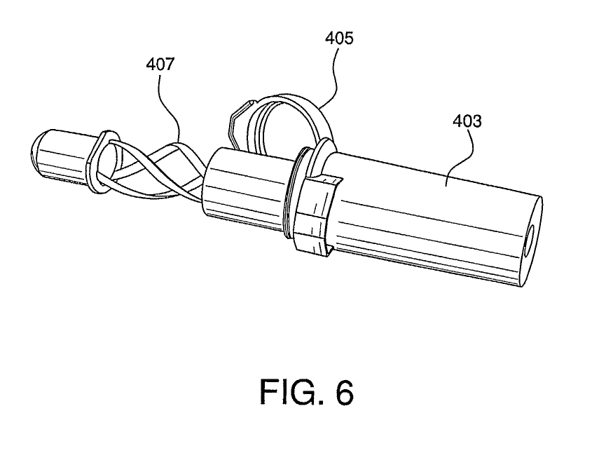

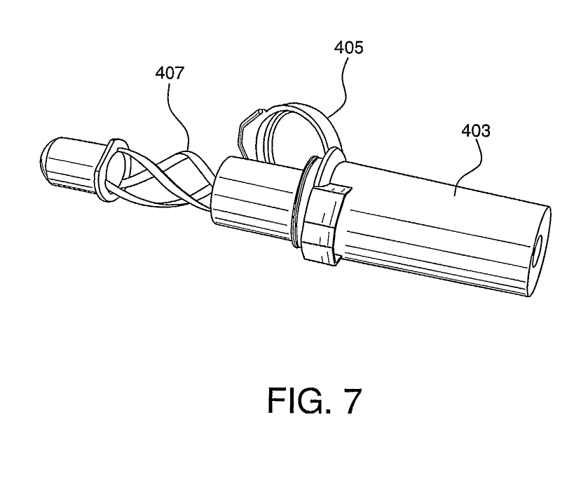

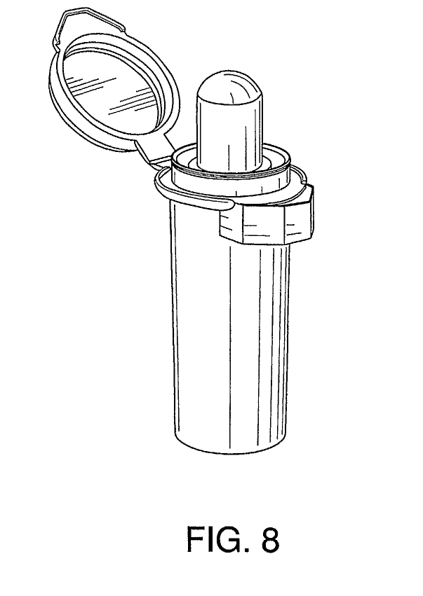

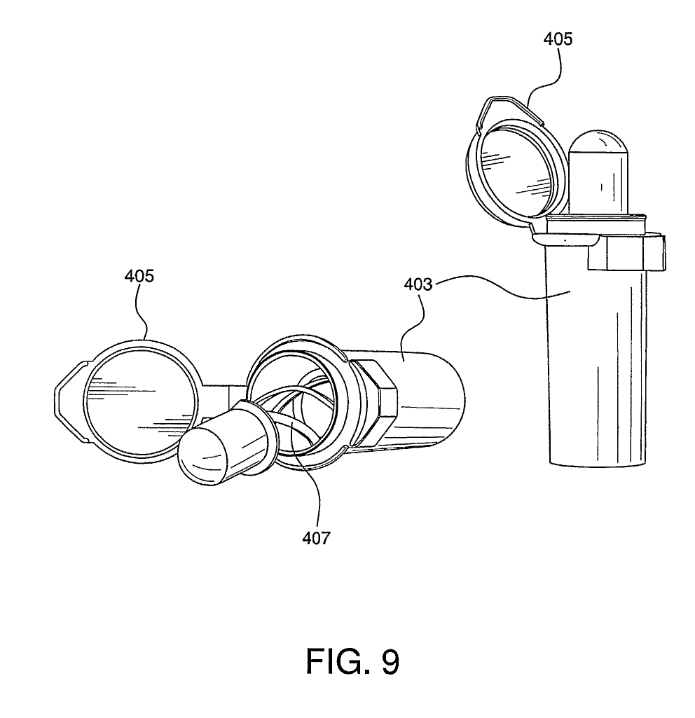

Referring now to FIGS. 4-9, a lollipop type dispensing apparatus (e.g., for self medication for chronic pain—such as cancer) is provided. This apparatus may comprise a spring loaded vial with dissolvable medication attached to the spring-loaded platform. In operation, the user may open the vial and the dissolvable medication may be elevated out of the vial. The user may take what they need and re-close the vial (the medication may thus be left clean for re-use).

As mentioned above, this aspect of the present invention relates to an oral medication dispenser, and more particularly to a self-medicating medication dispenser. An oral medication delivery device provides patient access to medications prescribed to be available on an as-needed basis. In the past, self-medicating devices have typically been available with a minimum time interval between the doses. The required time interval between drug accessibility was programmed into the device. In the present invention, the user has access to an as-needed dose of the medication at the onset of pain. Of this, this device may be used by those patients in chronic pain where an electronic self-medicating apparatus is not available.

Moreover, since the medication is loaded into the container, a patient has access to only a prescribed amount of the medication. The patient may gain access to the medication by opening the flip-top container, wherein a spring loaded lollipop type stick is advanced to the opening of the container. The medication may be administered by the patient licking the lollipop type stick. The lollipop type stick may be made of an absorbable material that is able to hold the medication. Once the medication has been accessed by the patient, the lollipop type stick may be lowered automatically by the spring load, back into the container and the lid can be closed. For the next use, the lid is opened, the stick comes up from the container and the process begins again.

Referring again to FIGS. 4-9, it is noted that in these embodiments the present invention may comprise a one-piece Vial Assembly 401 having Container 403 and Cap 405. The Container 403 and Cap 405 may be joined together by a hinge, therefore Vial Assembly 401 may be an interconnected assembly in which Cap 405 is opened and closed in a “flip-top” arrangement. Further, Vial Assembly 401 may contain Spring 407 positioned and secured at the bottom of Container 403. Vial Assembly 401 may optionally include tamper-evident and/or child resistant features. As explained, positioned and secured (e.g., in the center of Spring 407) is a lollipop type dispensing apparatus which dispenses the medication.

While a number of embodiments of the present invention have been described, it is understood that these embodiments are illustrative only, and not restrictive, and that many modifications may become apparent to those of ordinary skill in the art. For example, any steps described herein may be carried out in any desired order (and any desired steps may be added and/or deleted).

What is claimed is:

1. A resealable container and cap assembly for dispensing medication, comprising:
a container portion;
a cap portion;
a hinge joining the container portion and the cap portion;
a spring element disposed within the container portion; and
a lollipop type medicine dispensing apparatus retained by the spring element.

2. The assembly of claim 1, wherein the spring element is joined to an inside of the container portion.

3. The assembly of claim 1, wherein the spring element is joined to an intermediate member and the intermediate member is disposed inside of the container portion.

4. The assembly of claim 3, wherein the intermediate member is retained inside of the container portion.

5. The assembly of claim 1, wherein the spring element is a helical-type spring.

6. A resealable container and cap assembly for dispensing test strips, comprising:
a container portion;
a cap portion;
a hinge joining the container portion and the cap portion;
a spring element disposed within the container portion; and
an elevating cup which receives the test strips;
wherein the elevating cup is pressed down into the container portion by the cap portion when the cap portion is moved to a closed position; and
wherein the elevating cup is moved up, at least partially out of the container portion, by the spring element when the cap portion is moved to an open position.

7. The assembly of claim 6, wherein the spring element is joined to an inside of the container portion.

8. The assembly of claim 6, wherein the spring element is joined to an intermediate member and the intermediate member is disposed inside of the container portion.

9. The assembly of claim 8, wherein the intermediate member is retained inside of the container portion.

10. The assembly of claim 6, wherein the spring element is a helical-type spring.
